(19) United States
(12) Patent Application Publication
(10) Pub. No.: US 2004/0143471 A1
(43) Pub. Date: Jul. 22, 2004

(54) Pioneer software methods for using the internet, and all of the words and concepts it displays, in any form, as an inventive, creative, means

(76) Inventor: James Arlo Lehman, Fond Du Lac, WI (US)

Correspondence Address: JAMES A. LEHMAN, 179 W. DIVISION ST., FOND DU LAC, WI, 54935, US

(21) Appl. No.: 10/747,348

(22) Filed: Dec. 29, 2003

Related U.S. Application Data
(63) Continuation-in-part of application No. 09/728,370, filed on Dec. 4, 2000.

(51) Int. Cl. G06F 17/60

(52) U.S. Cl. 705/7

(57) ABSTRACT

Pioneer software methods for using the internet, and any of the inventors authored, inventive, creative, works on the internet, and all of the words, concepts, and lists they display, in any form, literary or pictorial, as an interactive, inventive, creative, means, via the juxtaposition of words and or concepts on any web enabled appartatus, of any kind, with the lists, in some instances, being automated, and some of the automated lists being constructable by the user of the inventors authored inventive-internet.com website. Further, to the extent possible, the teachings my also be used on any non web enabled software computer video display system.

### CROSS-REFERENCE TO RELATED APPLICATIONS

This is a continuation and improvement of pending application Ser. No. 09/728,370, Filed: Dec. 4, 2000 Art Unit: 3629 for: Creative method supplementing all of the copyrighted and patent applied for creative art of the inventor with all of the art of the internet, as a whole, for developing inventions or prospects for inventions. The earlier filing date of this application is hereby claimed.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The field of the endeaver of the instant invention pertains to is: inventing via or on the the internet using the concepts on the internet (be they words, pictures or symbols etc) that are on lists or are not on lists, which then can be juxtaposed against each other or key words or concepts or lists via methods developed by the inventor, which are on software that is on an internet site or seperate from the internet.

No other such art or teachings exist, and because the PTO has seemingly assigned a new Art Unit Number for this patent application it is provably a “first of its kind” and entitled to special allowances and advantages.

Further, the instant invention is the one creative/inventive method that the world has been looking for because the internet is everywhere so any person can use it to invent with. And, because the methods are the most comprehensive and productive of all time.

Toward that end there is a great need for the instant invention.

2. Description of Related Art Including Information Disclosed Under 37 CFR 1.97 and 1.98

Not Applicable, there is not any such internet art.

### BRIEF SUMMARY OF THE INVENTION

The invention is an unequaled aid to creativity and invention which can be used by nearly anyone in the world due to the internet and the like being available around the world. Further, it enables anyone in the world, from a scientist to a child to become inventive or more inventive due to the pioneer methods used, which on one hand make inventing very easy, and on the other hand makes the process of inventing as comprehensive and productive as is possible—due to the profound teachings, which can enable any person in the world to juxtapose almost any concept in the world against any other concept in the world to develope inventions utilizing the immense source of concepts and information found on the internet or like means.

The objects of the invention are to:

a. enable people around the world to be able to match (juxtapose) almost any concept in the world against any other concept in the world to develope inventions or creations using one entity—the internet or like means.

b. provide the most comprehensive inventive tool in history.

c. provide the most useful inventive tool in history

d. provide an inventive tool useful by almost anyone in the world

These and other features and objects will be apparent upon consideration of the following detailed description of preferred embodiments thereof.

### BRIEF DESCRIPTION OF THE SEVERAL VIEWS OF THE DRAWING(S)

Not Applicable, no drawings.

### DETAILED DESCRIPTION OF THE INVENTION

The internet has become ubiquitous, and a source for any number of different uses these days, but no party, to date, has developed methods for using the internet and all of the concepts that it displays, as an inventive, creative, means, which is why the the applicant has filed this improvement of his Invendex t.m. booklet art, and concepts, and word lists etc. (see Exhibit A, shown after page 5 with with the other exhabits) for a sample page from the Invendex, Inventor's Index t.m., which shows the basic method for juxtaposing key words or concepts and list words or concepts to invent with, which method the inventor was the first to invent, detailed in his book, The Creator t.m. in 1987) to include the art, and concepts, and lists (or not) of the internet, thus dramatcally expanding its capability to invent via the juxtaposition of concepts (words, pictures, symbols etc.) resulting in an extremely useful, productive, inventive, creative, tool.

Also, it should be noted that not long after The Creator the inventor wrote that a book entitled “The Inspirator” and in those series of books he taught using not only key words and lists to invent with but also key concepts (words, pictures, symbols etc) to invent with via the juxtapositioning of concepts—showing a method for creating new doll designs via pictures etc. Again, he was the first in the world to develope such methods, per statements made by an examiner for the PTO in his examination of a patent application regarding these matters

Going back to Exhibit A it must be pointed out that it gives the essence of the inventive process utilized with any and all juxtaposions of key words against list words or non list words, and key concepts against list words or concepts or non list words or concepts. And, Exhibit 13 (also from the Invendex t.m.) shows a picture of a bike frame above a list of words on an index of a book on bicycles might have, and a way to invent with that.

Further, new inventions, like cheesehead, are always described by a new set of words Incidently, new inventions make ideal candidates for key words or key concepts (key concepts can be words, but also pictures, or symbols etc) because the door is wide open for imporvements developed by adding words (or concepts) to the words or concepts which define the new invention.

And, if you do not have a key word or key concept in mind to use to invent with, via juxtpositions, you can pick one from the lists of the books of the inventor (such as shown in Exhibit A, see the list words from Pebble to Pop Gun) or the or from lists, catalogs, and indexes, and the like found on the internet or from non lists on the internet or the like, such as newspapers or magazines.

Regarding catalogs, they can be especially useful in this inventive process as often they have lists of pictures (which can be called a concept list) like doll dresses which could be juxtaposed with a doll design (say of a tall, young teen girl) as the key concept, with a word description above, to work with as lists (so to speak) and then by draging a window or box with either a key word or key concept in it the juxtapositions (matching) of the words and or concepts can proceed by viewing what is seen taking note of what combinations of words and or concepts define inventions.

All of the methods of the instant invention can be used in literary expressions or pictorial depictions in printed materials such as books or with any such art on the the internet, or any other kind of art on the internet. See Exhibit C for a sample of a book (The Bicycle) which may be on the internet and useable as a source for lists (see the index—indexes are very useful with the methods of the instant invention) and pictures (see the picture of the bicycle frame) to invent with. See the first page of Exhibit C for the details of one of the inventor/authors previous methods using the Dewey Decimal System to invent with.

Indeed the author/inventor has copyrighted many writings etc. with methods of all sorts using key words or concepts and list words or concepts, and lists of all sorts, to invent with, and Exhibit D (an old listing of Jan. 7, 2002) from the Copyright Offiice (which shows some of them. Note: that list was not even complete for some reason, and since then the author/inventor has added many more.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed as new and useful is:

1. pioneer sofware methods for using the internet, and any of the words and concepts it displays, in any form, as an inventive, creative, means:

2. pioneer software methods for using the internet, and any of the inventors authored, inventive, creative, works on the internet, and all of the words, concepts, and lists they display, in words or pictures etc., in any form, as an interactive, inventive, creative, means, using the juxtaposition of individual words or concepts, as key words or concepts, list words or concepts, or non list words or concepts, which match up with other such individual concepts, to define an invention or prospect on any kind of web enabled appartatus.

3. The method of claim 2, whereby any word or concept from the users mind or shown on the appartatus from a list of the author/inventor or not or non list, may be made a key concept or key word and then by juxtaposing the key concept or key word against a list concept or list word or non list word or concept until a combination of a key word or concept and a list word or concept or non list word or concept is happened upon, which describes, defines or otherwise details an invention or creation or a prospect for an invention or creation.

4. The method of claim 2, whereby. concepts or words in writings, drawings, and lists on any part of the inventor's authored writings: such as The Creator t.m., The Inspirator t.m., Invendex, Inventor's Index t.m., and on his website: inventive-internet.com, may be displayed on the internet and made part of the internet and made matchable with any other concepts or words on the authored works or on the internet to define inventions or prospects by the matchups.

5. The method of claim 2, whereby the word or concept may be made a key word or concept to invent with, and then entered in a blank space or slot or box or window which may be provided or superimposed on any kind of the display or screen for the entry or deletion of the key word or key concept or a list word or list concept or non list word or concept so as to keep tract of and use those concepts on the display or screen during the process of making juxtapositions, and to facilitate that process.

6. The method of claim 2, whereby any search engine on the internet may be used as an inventive, creative, means.

7. The method of claim 2, whereby. any website or web page on the internet may be used as an inventive, creative, means.

8. The method of claim 2, whereby any of the lists of the author may be automated in that by the click of an icon, a combinations icon or Automated List t.m. icon, for example, a key word or key concept and list words or list concepts on the authors works, in the various types and forms of lists, may be matched against each other to produce combinations of words which may define an invention or prospect as is shown on the Automated Lists t.m. on the inventor's inventive-internet website.

9. The method of claim 8, whereby the automated lists of the author on his inventive-internet.com website may made from pre-existing lists of various kinds, literary or pictorial, and subjects, such as Things, Function, and Shapes as are found on many of the author/inventors works.

10. The method of claim 8, whereby automated lists may be constructed by the user by clicking on an icon, such as a create a list icon, on the inventors website or on any software having the create a list art, and when the create a list page appears for the entry of the list words the user can type in words, of any kind, after clicking on a type list icon, and then type in two to an endless list of words, on one to endless columns of words, which then can be automatically matched against each other, one list word against another list word, one matching at one time, with all of the match ups then being displayable after clicking on a combinations icon.

11. The method of claim 4, whereby. the lists of the author on his website on the internet, in various ways, may be automated in that by the click of an icon on the website, an Automated List t.m. icon for example, a key word, and the list words may be matched against each other, with each individual word being matched against the other individual words to define inventions or prospects for inventions.

12. The method of claim 2, whereby the lists are pre constructed word lists of the author, and the list words are automatically matchable against a key word positioned on the Automated List t.m., either being typed in or transfered from the Inventor's Menu, TTT t.m.on the inventor/ authors website on the internet, after clicking on the 72 combinations icon on the menu, and then the key word is automatically matched, and shown, against the list words, after clicking on one of the icons for: Things, Function or Shapes list, on the Use List section of the Automated List t.m page, and the before or after icon, on the Keyword Placement section of the page, meaning the key word will show either before or after the list words, and then on one of the letters of the alphabet listed in the Starts With Letter section, meaning the list words, section, and thereafter the word combinations of the key word, and the list words, as classified, shows on a seperate section or page of the website.

13. The method of claim 2, whereby a list of list words may be constructed by the user on the website, and made automated by first clicking on a create a list icon, anywhere on the website but prefably below the Inventor's Menu, TTT t.m., and when the create a list blank page shows the list of list words can be typed, and after the typing they can be matched against each other, one to one, to define inventions or prospects, after clicking on a combinations icon on the create a list page, and reading the columns of match ups shown, which may be brief or nearly endless depending on the amount of words typed in.

14. The method of claim 2, whereby the pictorial lists used to invent with may be from the authors works, only, or internet art, only, or a combination of the two.

15. The method of claim 5, whereby the key concept used in the slot, window etc. may be a picture or drawing of any kind.

16. The method of claim 4, whereby the website is the first interactive, inventive, creative website in history.

17. The method of claim 2, whereby to the extent possible, the teachings may also be used on any non web enabled

18. The method of claim 13, whereby the create a list icon, type list icon, and combinations icons are part of the inventors interactive, inventive website software, and fully operate on the website.

19. The method of claim 13, whereby the create a list icon, type list icon, and combinations icon, and their functions, can be part of any software useable on the internet or anywhere else software can be used to invent with via a computer video display system.
